(19) United States
(12) Patent Application Publication
(10) Pub. No.: US 2014/0234808 A1
(43) Pub. Date: Aug. 21, 2014

(54) STUDY GAMES KIT

(71) Applicant: Kevin Munn, Toronto (CA)

(72) Inventor: Kevin Munn, Toronto (CA)

(21) Appl. No.: 14/185,880

(22) Filed: Feb. 20, 2014

Related U.S. Application Data
(60) Provisional application No. 61/766,764, filed on Feb. 20, 2013.

(51) Int. Cl. G09B 19/22

(52) U.S. Cl. CPC G09B 19/22
USPC 434/129

(57) ABSTRACT

A study games kit is disclosed. The study games kit may include a plurality of game pieces that correspond to each of the one or more player users playing one or more mini-games, the game pieces are moved on the spaces that may require the one or more player users to draw cards and answer questions. The study games kit may also be a Quadrathlon style study games kit wherein each of the mini-games is played one after the other and the one or more player users win points throughout a series before the points are tallied up at the end of the series.

This application claims priority to U.S. Provisional Application 61/766,764 filed on Feb. 20, 2013, the entire disclosure of which is incorporated by reference.

### BACKGROUND OF THE INVENTION

1. Field of the Invention

The present invention is a study game. More specifically, the present invention is a study game kit.

2. Description of the Related Art

Most students find studying boring and dull and thus do not want to study and most games on the market for studying are very specific in the material they review and cannot accommodate a variety of study subjects or learning needs.

The study game kit solves this problem by making studying a game more fun and appealing to students and making it easy to include virtually any desired study material in the included study games. It does this by delivering a pre-made kit of fun and easy to play mini-games in which the one or more player users may include virtually any study material subject they choose by writing it on the included cards, game pieces and other materials and then review the material as they play the mini-games.

### BRIEF SUMMARY OF THE INVENTION

The present invention is a study game. More specifically, the present invention is a study game kit.

The study game kit is designed to be able to include any subject of study into a series of provided mini-games in a game board type format that is convenient and portable.

The study game kit includes a plurality of mini-games, some of which are played on a game board, others of which are played by utilizing a plurality of cards and a plurality of game pieces. The mini-games include a plurality of sticky notes which are utilized to write questions that correspond to a plurality of study materials. Each mini-game has a plurality of game pieces that correspond to each of the one or more player users' playing the mini-games. For the board game style, mini-games include the game pieces are moved on the spaces that include the questions disposed on the spaces and the draw cards corresponding to the spaces they land on. For the card game, the mini-games each include a plurality of cards to place the questions on as well as the game pieces that correspond to each of the one or more player users and the mini-game. The study game kit may also be a Quadrathlon style study games kit wherein each of the mini-games is played one after the other and the one or more player users win points throughout a series before the points are tallied up at the end of the series.

It is an object of the present invention to provide a study game kit that is designed to make reviewing study material fun by delivering it in a series of mini-games that are easy to utilize, convenient to bring to any location and flexible to include any study or learning material.

It is an object of the present invention to provide a study game kit that includes cards, game pieces and a game board that is simply designed so that subject material may be disposed on the cards and the game board prior to playing the mini-games and then reviewed as the mini-games are being played.

It is an object of the present invention to provide a study game kit that includes any subject the one or more player users' wishes to review that may be written onto a plurality of sticky notes that are placed on the game cards, unlike other games on the market which include specific material to review. The ability for the one or more player users to enter in their own material they wish to review before playing makes the mini-games personalized as to what the one or more player users wants to study and review.

It is an object of the present invention to provide a study game kit that includes mini-games that are designed so they may be played by one player user or played by a plurality of player users against each other.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a view of a study games kit, in accordance with one embodiment of the present invention.

FIG. 2 illustrates a flowchart of a method for utilizing a study games kit, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

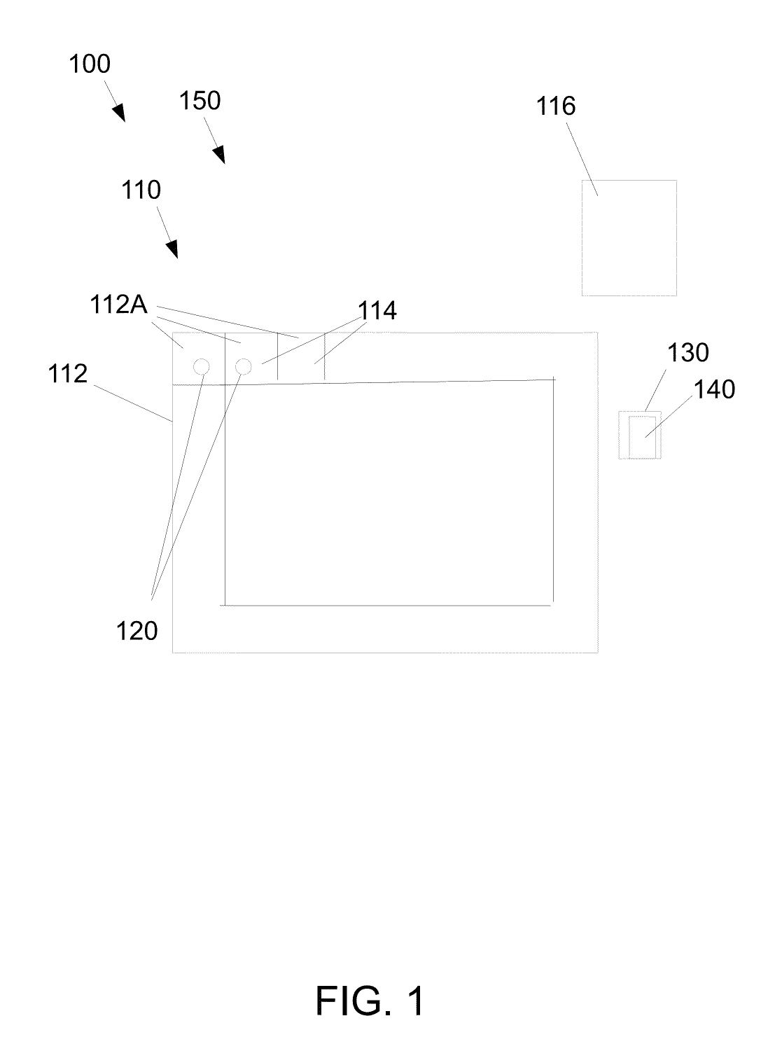

FIG. 1 illustrates a view of a study games kit 100, in accordance with one embodiment of the present invention.

The study games kit 100 may include a plurality of mini-games 110, a plurality of game pieces 120, a plurality of cards 130 and a plurality of sticky notes 140. The mini-games 110 may include a game board 112 that the mini-games 110 may be played on. The mini-games 110 may be played in sequence. The game board 112 may include a plurality of spaces 112A. The mini-games 110 may be any suitable game board game. The mini-games 110 may include a plurality of questions 114 that correspond to a plurality of study materials 116. The questions 114 may be disposed on the spaces 112A while playing the mini-games 110. The mini-games 110 may be played by the one or more player users in which the one or more player users play against each other. The study materials 116 correspond to answers to the questions 114 disposed on the spaces 112A or the cards 130. The questions 114 and the study material 116 may be any suitable questions and study materials of any subject matter such as math, spelling, history or other suitable subject matter. The game pieces 120 may correspond to each of the one or more player users playing the mini-games 110. The game pieces 120 may be moved on the spaces 112A or the game pieces 120 that include the questions 114 disposed on the spaces or the cards 130. The one or more player users may answer the questions 114 disposed on the spaces 112A or the cards 130 that the one or more player users' game piece moved on. The cards 130 may include a corresponding answer to each question 114 disposed on the spaces 112A of the game board 112 or the game pieces 120. The cards 130 may allow the one or more player users to review the questions 114 and the study material 116 as the one or more player users play the mini-games 110. The sticky notes 140 may be utilized to receive one or more written questions. The sticky notes 140 may be placed on the cards 130 of the mini-games 110. The study games kit 100 may be a Quadrathlon style study games kit 150. The Quadrathlon style study games kit 150 may be defined as wherein each of the mini-games 110 is played one after the other and the one or more player users win points throughout the series before the points are tallied up at the end of the series.

As each of the mini-games 110 is played, the one or more player users answer the questions related to the study material 116. The one or more player users must answer the questions correctly to win points and complete each of the mini-games 110. As each of the mini-games 110 is played the study material 116 is reviewed as the questions 114 are asked in each of the mini-games 110. Points are won throughout each of the mini-games 110 for each correctly answered question and tallied up at the end of each of the mini-games 110. By the time the mini-games 110 are played, the study material 116 has been exposed to each of the one or more player users several times and thus has become much more familiar to each the one or more player users of the series. The study games kit has been tested in tutoring and teaching situations with a variety of students and study materials and has been developed into a simple yet effective and accommodating kit of mini-games. The game pieces of the mini-games have been designed for one or more player users to enter study material of any kind onto the game cards. The game pieces are then utilized in the included mini-games that allow the one or more player users to review the material as they play. The process of playing the mini-games achieves the goal of reviewing study material in a fun and engaging way. All game pieces are included for four or more mini-games which may be played separately or in a series. Each mini-game includes cards, game pieces and a plurality of sticky notes in which to write the desired study subject questions and answers and then place on the cards or the game board. The cards and game board then have study material disposed on them and the game is played in a game board game like fashion. As the game is played, the questions are answered during the course of the game to review the material. The one or more player users must answer correctly to win points and complete each game. Each game may be played on its own, in which each game is played one by one. As each game is played the desired study material is reviewed throughout the questions in each game. Points are won throughout each game and tallied up at the end. By the time the mini-games are all played, material has been reviewed several times and thus has become much more familiar to the one or more player users. Therefore, material is reviewed in depth but in a fun and engaging way that makes studying much more likely to be made a habit of.

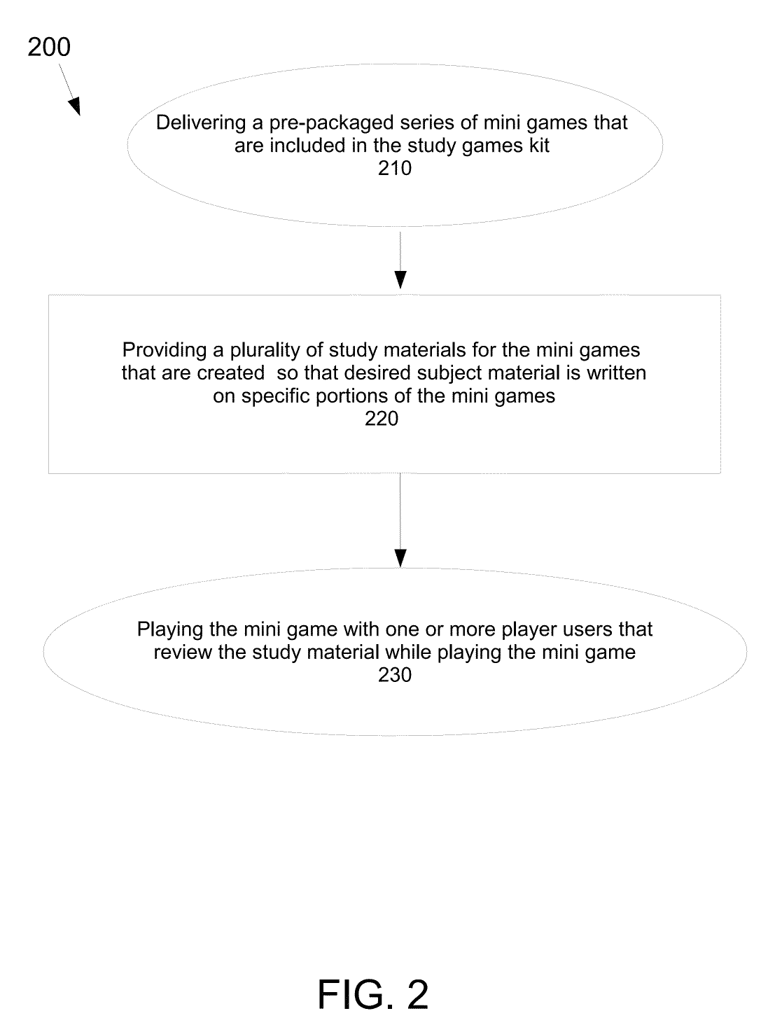

FIG. 2 illustrates a flowchart of a method 200 for utilizing a study games kit, in accordance with one embodiment of the present invention.

The method 200 may include the steps of delivering a pre-packaged series of mini-games that are included in the study games kit 210, providing a plurality of study materials for the mini-games that are created so that desired subject material is written on a plurality of sticky notes which are placed on specific portions of the mini-games 220 and playing the mini-game with one or more player users that review the study material while playing the mini-game 230. The delivering step 210 may include designing the mini-games to make reviewing the study material fun. The providing step 220 may include entering desired study material and corresponding questions to review onto a plurality of cards and a plurality of game board spaces. The playing step 230 may include combining a plurality of mini-games to generate points which the one or more player users compete for by reviewing the study material during the course of the mini-games and points from each mini-game that are combined to make a final score.

Utilization of the study game kit is straightforward. The study game kit is a pre-packaged series of mini-games that are included in the kit that are designed to make reviewing study material fun by delivering it in a series of entertaining mini-games. All necessary materials for the mini-games are included and are created so that desired subject material may be written on sticky notes and placed on specific game pieces of the mini-games. There is no predetermined study or subject material included with the game. Instead the one or more player users enter in the material they want to review onto the sticky notes which are placed on the cards and game pieces of the mini-games. The mini-games are then played and the material is reviewed during each game. The mini-games included may be played by one person or with the one or more player users or students. Each mini-game may be played to review material or may be combined to make a study game in which each mini-game is a separate event to win points which the one or more player users compete for by reviewing the material during the course of the mini-games.

The study game kit is utilized for review in learning study material and academics in a fun and engaging format. It may be utilized for tutoring, teaching, and studying in groups or studying alone. Because of the convenience, simplicity and flexibility of the mini-games included in the kit, it may be easily utilized to incorporate virtually any subject of study and virtually any grade level of student. Most any material that the one or more player users wishes to review or to teach may be simply written onto the sticky notes and placed on the included game pieces and then reviewed as the mini-games are played.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A study games kit, comprising:
a plurality of mini-games including a game board and a card game style game, the game board includes a plurality of spaces that require answering questions and the card style game include a plurality of questions that correspond to a plurality of study materials;
a plurality of game pieces corresponding to each of one or more player users playing the mini-games, the game pieces are moved on the spaces that include the questions disposed on the spaces; and
a plurality of cards having a plurality of questions, the cards are utilized as the mini-games are played
a plurality of sticky notes utilized to receive written questions, the sticky notes are placed on the cards of the mini-games.

2. The study games kit according to claim 1, wherein the study materials correspond to answers to the questions disposed on the cards.

3. The study games kit according to claim 1, wherein the mini-games are played in sequence.

4. The study games kit according to claim 1, wherein the mini-games are played individually.

5. The study games kit according to claim 1, wherein the questions are disposed on the cards while playing the mini-games.

6. The study games kit according to claim 1, wherein the mini-games are played by the one or more player users.

7. The study games kit according to claim 6, wherein the mini-games are played by the one or more player users in which the one or more player users play against each other.

8. The study games kit according to claim 1, wherein the one or more player users answer the questions disposed on the game cards as indicated by spaces that the one or more player users' game pieces moved on.

9. The study games kit according to claim 1, wherein the cards allow the one or more player users to review the questions and the study material as the one or more player users play the mini-games.

10. A Quadrathlon style study games kit, comprising:
a plurality of mini-games including a game board that the mini-games are played on, the game board includes a plurality of spaces and the mini-games include a plurality of questions that correspond to a plurality of study materials, wherein each of the mini-games is played one after the other and one or more player users win points throughout a series before the points are tallied up at the end of the series;
a plurality of game pieces corresponding to each of the one or more player users playing the mini-games, the game pieces are moved on the spaces that indicate to draw question disposed on the spaces; and
a plurality of cards including a plurality of questions from the desired study material disposed on them.

11. The study games kit according to claim 10, wherein the mini-games are played in sequence.

12. The study games kit according to claim 10, wherein the questions are disposed on the cards while playing the mini-games.

13. The study games kit according to claim 10, wherein the mini-games are played by the one or more player users.

14. The study games kit according to claim 13, wherein the mini-games are played by the one or more player users in which the one or more player users play against each other.

15. The study games kit according to claim 10, wherein the one or more player users answer the questions from the cards disposed on the spaces that the one or more player users' game pieces moved on.

16. The study games kit according to claim 10, wherein the cards allow the one or more player users to review the questions and the study material as the one or more player users play the mini-games.

17. A method for utilizing a study games kit, comprising the steps of:
delivering a pre-packaged series of mini-games that are included in the study games kit;
providing a plurality of study materials for the mini-games that are created so that desired subject material is written on specific portions of the mini-games; and
playing the mini-game with one or more player users that review the study material while playing the mini-game.

18. The method according to claim 17, wherein the delivering step includes designing the mini-games to make reviewing the study material fun.

19. The method according to claim 17, wherein the providing step includes entering desired study material and corresponding questions to review onto a plurality of cards and a plurality of game board spaces.

20. The method according to claim 17, wherein the playing step includes combining a plurality of mini-games to generate points which the one or more player users compete for by reviewing the study material during the course of the mini-games and points from each mini-game that are combined to make a final score.
